(19) United States
(12) Patent Application Publication
(10) Pub. No.: US 2005/0240767 A1
(43) Pub. Date: Oct. 27, 2005

(54) Encoding and decoding of watermarks in independent channels

(76) Inventors: Aweke Negash Lemma, Eindhoven (NL); Javier Francisco Aprea, Eindhoven (NL); Alphons Antonius Maria Lambertus Bruekers, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/516,145

(22) PCT Filed: May 21, 2003
(86) PCT No.: PCT/IB03/02164

§ 371 Date: Nov. 30, 2004

(30) Foreign Application Priority Data
Jun. 3, 2002 (EP) 02077171.3

(51) Int. Cl. H04L 9/00

(52) U.S. Cl. 713/176

(57) ABSTRACT

Methods and apparatus for embedding a watermark in a multimedia signal and detecting the watermark, are described. The method comprises the steps of generating a watermark signal comprising a first sequence of values and a second sequence of values; obtaining a first signal portion corresponding to a first channel and a second signal portion corresponding to a second channel from the multimedia signal, said channels being significantly independent; generating a first host modifying signal as a mixture of the first signal portion and the first sequence; generating a second host modifying signal as a mixture of the second signal portion and the second sequence; and generating a watermarked multimedia signal by combining scaled versions of the host modifying signals with the multimedia signal.

The present invention relates to apparatus and methods for encoding and decoding of watermarks in multiple channels of multimedia signals, such as audio, video or data signals.

Watermarking of multimedia signals is a technique for the transmission of additional data along with the multimedia signal. For instance, watermarking techniques can be used to embed copyright and copy control information into audio signals.

The main requirement of a watermarking scheme is that it is not observable (i.e. in the case of an audio signal, it is inaudible) whilst being robust to attacks to remove the watermark from the signal (e.g. removing the watermark will damage the signal). It will be appreciated that the robustness of a watermark will normally be a trade off against the quality of the signal in which the watermark is embedded. For instance, if a watermark is strongly embedded into an audio signal (and is thus difficult to remove) then it is likely that the quality of the audio signal will be reduced.

Encoding payloads (information that can be subsequently recovered) into robust watermarks is not a trivial issue. Various solutions have been proposed on how recoverable information can be encoded during the embedding procedure.

For instance, one type of audio watermarking scheme is to use temporal correlation techniques to embed the desired data (e.g. copyright information) into the audio signal. This technique is effectively an echo-hiding algorithm, in which the strength of echo is determined by solving a quadratic equation. The quadratic equation is generated by auto-correlation values at two positions: one at delay equal to τ and one at delay equal to 0. At the detector, the watermark is extracted by determining the ratio of the auto correlation function at the two delay positions.

U.S. Pat. No. 5,822,360 describes how auxiliary data can be transported in a conventional audio signal by hiding the data in the form of colored noise. The colored noise has a spectrum that simulates the spectrum of the primary audio signal. The technique includes the concept of transporting a plurality of auxiliary information signals by modulating a plurality of pseudorandom noise carriers by the information signals so as to provide a plurality of spread spectrum signals. Such a superimposition can cause collision of the information signals (i.e. the watermarks), thus reducing the detectability of all of the watermarks.

WO 00/00969 describes an alternative technique for embedding or encoding auxiliary signals (such as copyright information) into a multimedia host or cover signal. A replica of the cover signal, or a portion of the cover signal in a particular domain (time, frequency or space), is generated according to a stego key, which specifies modification values to the parameters of the cover signal. The replica signal is then modified by an auxiliary signal corresponding to the information to be embedded, and inserted back into the cover signal so as to form the stego signal.

At the decoder, in order to extract the original auxiliary data, a replica of the stego signal is generated in the same manner as the replica of the original cover signal, and requires the use of the same stego key. The resulting replica is then correlated with the received stego signal so as to extract the auxiliary signal.

In such watermarking schemes the additional data to be embedded within the multimedia signal typically takes the form of a sequence of values. This sequence of values is then converted into a slowly varying narrow-band signal by applying a window shaping function to each value.

It is an object of the present invention to provide a technique that allows an increase in the payload of a watermark.

It is an object of the present invention to provide a watermarking scheme that substantially addresses at least one of the problems of the prior art, whether referred to herein or otherwise.

In a first aspect, the present invention provides a method of embedding a watermark in a multimedia signal, the method comprising: generating a watermark signal comprising a first sequence of values and a second sequence of values; obtaining a first signal portion corresponding to a first channel and a second signal portion corresponding to a second channel from the multimedia signal, said channels being significantly independent; generating a first host modifying signal as a mixture of the first signal portion and the first sequence; generating a second host modifying signal as a mixture of the second signal portion and the second sequence; and generating a watermarked multimedia signal by combining scaled versions of the host modifying signals with the multimedia signal.

Preferably, the first and second channels are selected from a predetermined set of significantly independent channels.

Preferably, said channel selection occurs in dependence upon a payload of the watermark signal.

Preferably, said channel selection occurs in dependence upon predetermined characteristics of the multimedia signal.

Preferably, the first and second sequences are selected from a predetermined set of watermark sequences.

Preferably, the watermark selection occurs in dependence upon a payload of the watermark signal.

Preferably, said watermark comprises at least one further sequence of values; and the method further comprises the steps of: obtaining at least one further signal portion corresponding to a further channel from the multimedia signal, said first, second, and said further channel being significantly independent; generating at least one further host modifying signal as a mixture of said further sequence and said further signal portion.

Preferably, said channels are obtained from the multimedia signal by filtering the multimedia signal using at least one of time filters, frequency filters or spatial filters.

Preferably, said channels are obtained by applying orthogonal data projection techniques into orthogonal code spaces.

Preferably, said first and second channels are mutually orthogonal.

Preferably, said second sequence of values is a circularly shifted version of said first sequence of values.

Preferably, said first and second signal portions are substantially the same.

Preferably, said first and second sequence of values are substantially the same.

In a further aspect, the present invention provides an apparatus arranged to embed a watermark in a multimedia signal, the apparatus comprising: a watermark signal generator arranged to generate a watermark signal comprising a first sequence of values and a second sequence of values; a channel signal portion extractor arranged to obtain a first signal portion corresponding to a first channel and a second signal portion corresponding to a second channel from the multimedia signal, said channels being significantly independent; a host signal modifier arranged to generate a first host modifying signal as a mixture of the first signal portion and the first sequence; and further arranged to generate a second host modifying signal as a mixture of the second signal portion and the second sequence; and a combiner arranged to generate a watermarked multimedia signal by combining scaled versions of the first and second host modifying signals with the multimedia signal.

Preferably, the apparatus further comprises a database of significantly independent channels; and a channel selector arranged to select the first and second channels from said database.

In another aspect, the present invention provides a multimedia signal comprising a watermark, the watermark comprising at least a first sequence of values and a second sequence of values, and wherein a first signal portion corresponding to a first channel within the multimedia signal has been modified by the first sequence of values, and a second signal portion corresponding to a second channel within the multimedia signal has been modified by a second sequence of values, the first and second channels being significantly independent.

In a further aspect, the present invention provides a method of detecting a watermark signal embedded in a multimedia signal, the method comprising the steps of: receiving a multimedia signal that may potentially be watermarked by a watermark signal embedded within two significantly independent channels of the multimedia signal; extracting an estimate of the watermark from the two significantly independent channels of the received signal; and correlating the estimate of the watermark with a referenced version of the watermark so as to determine whether the received signal is watermarked.

Preferably, the watermark signal has a payload, and the method further comprises the step of determining the payload of the watermark.

Preferably, the method includes receiving, and extracting an estimate of the watermark, from three or more channels.

In another aspect the present invention provides a watermark detector apparatus arranged to detect whether a watermark signal is embedded within a multimedia signal, the watermark detector comprising: a receiver arranged to receive a multimedia signal that may potentially be watermarked by a watermark signal embedded within two significantly independent channels of the multimedia signal; a filter arranged to extract an estimate of the watermark from the two significantly independent channels of the received signal; and a correlator arranged to correlate the estimate of the watermark with a referenced version of the watermark so as to determine whether the received signal is watermarked.

Preferably, the apparatus further comprises a detector arranged to determine if a payload is present within said watermark, and to determine the value of said payload.

In a further aspect, the present invention provides a computer program arranged to perform at least one of the methods described above.

In another aspect, the present invention provides a record carrier comprising a computer program described above.

In a further aspect, the present invention provides a method of making available for downloading a computer program as described above.

For a better understanding of the invention, and to show how embodiments of the same may be carried into effect, reference will now be made, by way of example, to the accompanying diagrammatic drawings in which:

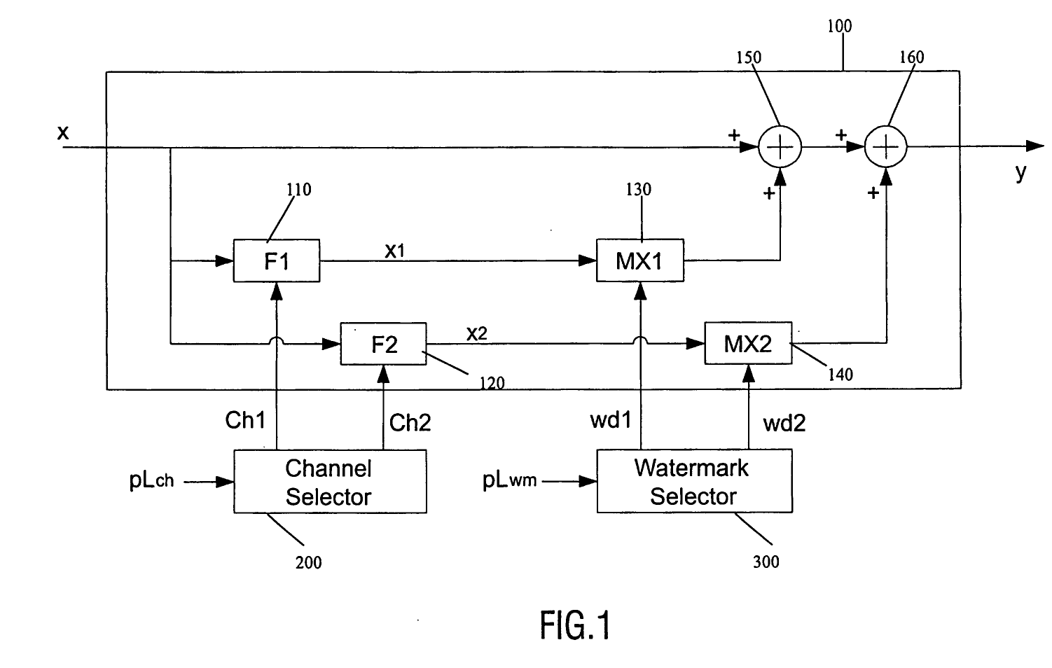

FIG. 1 shows a schematic diagram of a generalized embedder in accordance with an embodiment of the present invention;

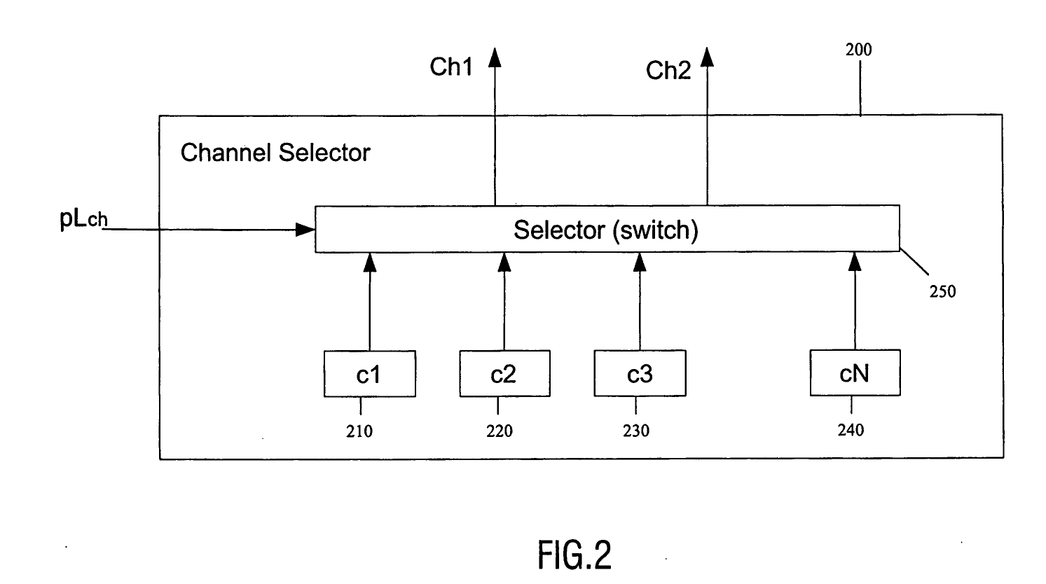

FIG. 2 illustrates a schematic diagram of a preferred embodiment of the channel selector shown in FIG. 1;

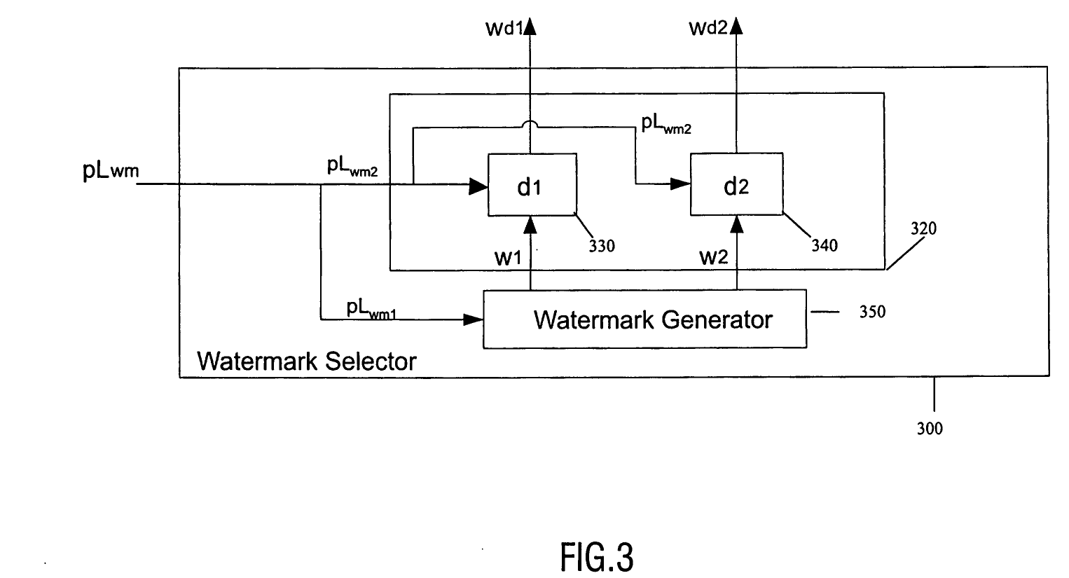

FIG. 3 illustrates a preferred embodiment of the watermark selector shown in FIG. 1;

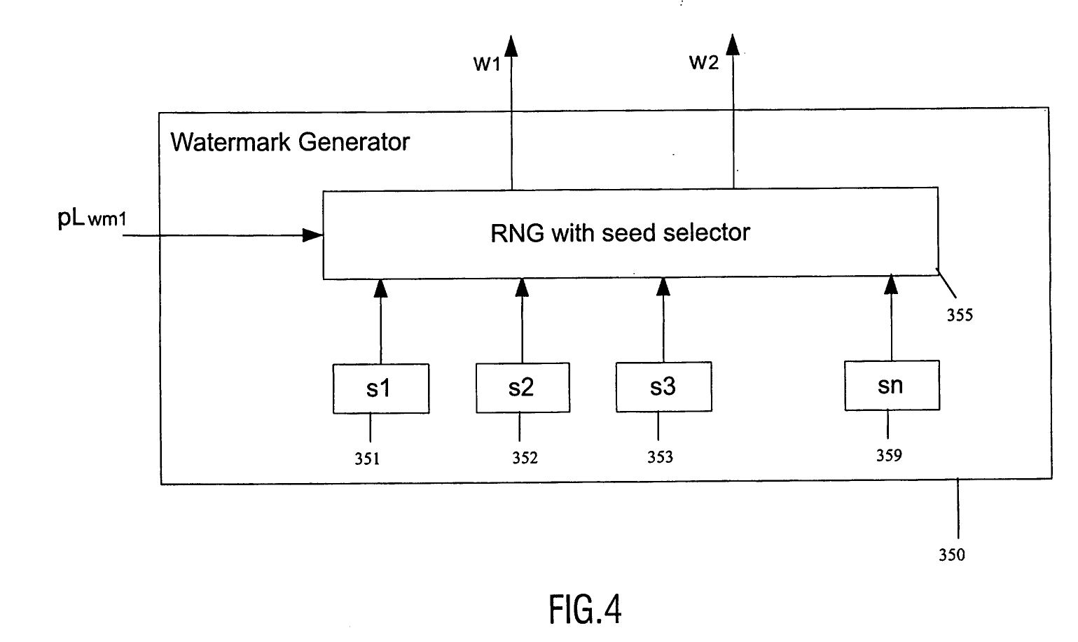

FIG. 4 illustrates a preferred embodiment of the watermark generator shown in FIG. 3;

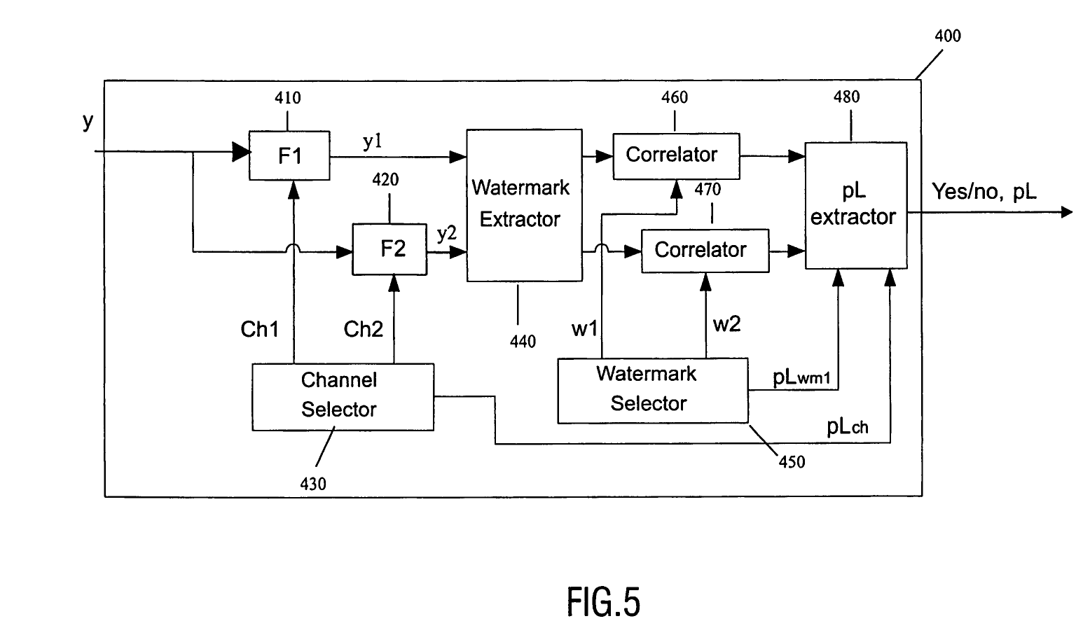

FIG. 5 illustrates a schematic diagram of a generalized detector according to an embodiment of the present invention;

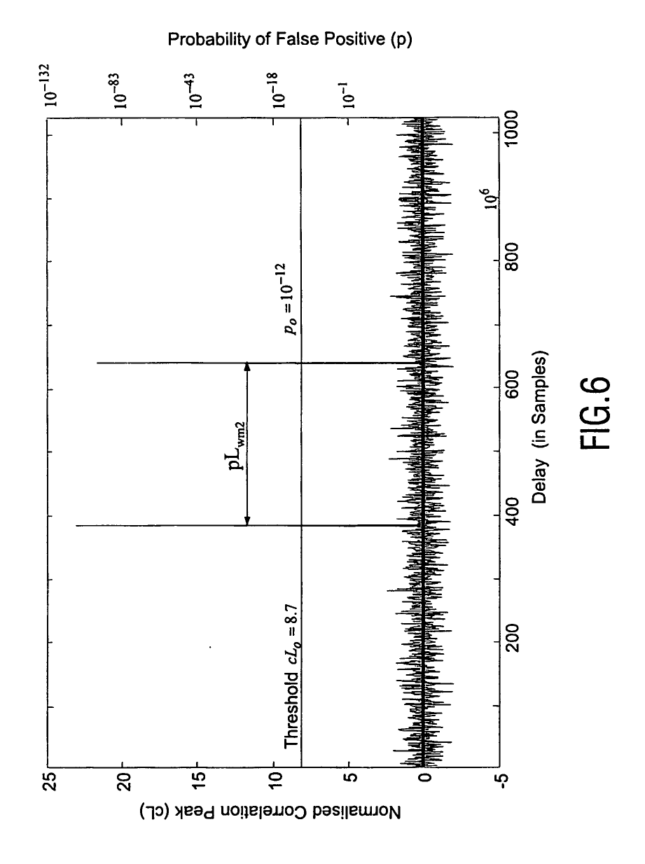

FIG. 6 illustrates typical detection correlation peaks;

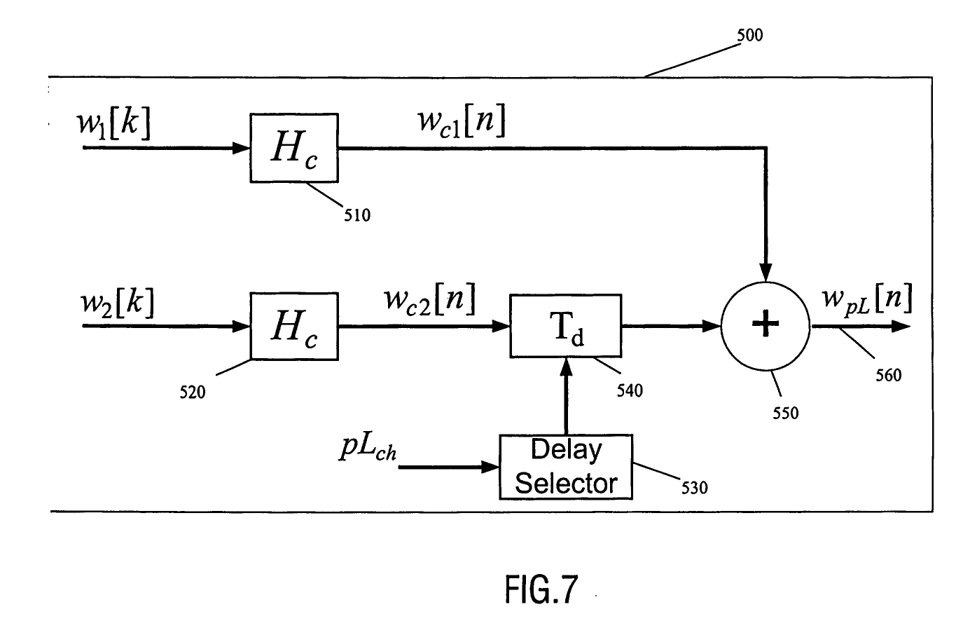

FIG. 7 illustrates a preferred embodiment for encoding the payloads with different relative delays;

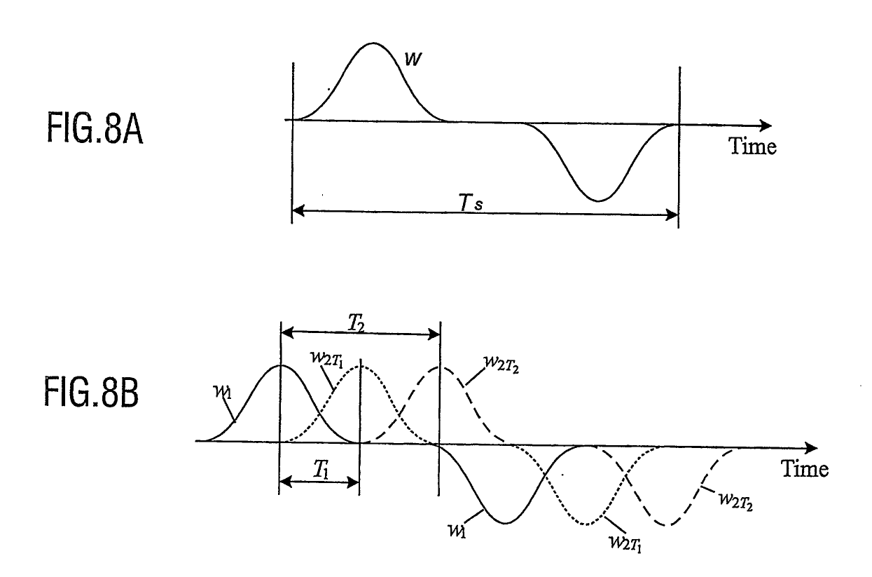

FIGS. 8A and 8B illustrate respectively a bi-phase window shaping function, and the resulting payloads formed by the use of the bi-phase window shaping function for different relative delays T₁ and T₂; and

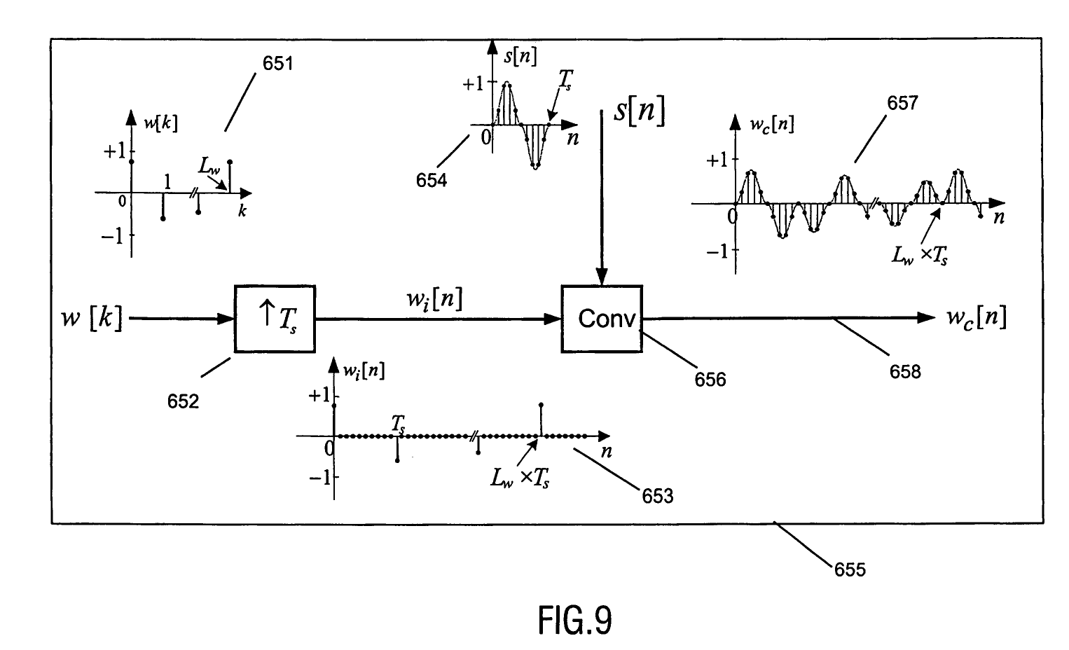

FIG. 9 illustrates a schematic diagram of a signal conditioning apparatus suitable for use in the selector shown in FIG. 7, with accompanying charts of the signals at each stage.

A technique for encoding payload in multimedia watermarking systems by embedding watermark sequences into mutually independent watermark channels is described. In this context, two watermark channels Ch₁ and Ch₂ are said to be mutually independent, if there exists a small positive real number ε such that all signals fᵢ(c) carried within the channel Ch₁ and all signals f₂(c) carried within the channel Ch₂ are such that

$$\frac{{\int }_{- ∞}^{∞} {\vert {f}_{1} ( c ) {f}_{2} ( c ) \vert}^{2} ⅆ c}{{\int }_{- ∞}^{∞} {\vert {f}_{1} ( c ) \vert}^{2} ⅆ c {\int }_{- ∞}^{∞} {\vert {f}_{2} ( c ) \vert}^{2} ⅆ c} \leq ɛ$$

where the product and integration are conducted in the domain where the channels are defined. Channel independence is considered at least in one of code, time, frequency or space. Two channels are said to be significantly independent if ε<0.7

Orthogonal channels are defined as special cases of independent channels, where ε=0. Whilst the term “independent channels” will be utilized throughout the description, it should be appreciated that all of the discussions equally apply to orthogonal channels as well.

FIG. 1 illustrates a schematic diagram of an embedder 100. The embedder 100 receives a multimedia signal x, and outputs a watermarked multimedia signal y, carrying payload information (pL). In this embodiment, the payload of the watermark (pL) comprises at least two portions—a channel selector portion (pL_{ch}) and a watermark selector portion (pL_{wm}).

A copy of the received signal x is passed to the first channel filter 110, and a copy is passed to the second channel filter 120. The first and second channel filters 110, 120 are utilized to extract the signals within x (x₁ and x₂) lying within the respective mutually independent channels Ch₁ and Ch₂. These signals (xᵢ and x₂) are obtained in this preferred embodiment by filtering the signal x using time, frequency or spatial filters F1 and F2 corresponding to the respective channels Ch₁ and Ch₂. For instance, if Ch₁ and Ch₂ are frequency channels corresponding to different frequency bands, then x₁ and x₂ are obtained by utilizing band-pass filters having pass bands matching Ch₁ and Ch₂, respectively. Note that x₁ and x₂ correspond to two independent channels so that they satisfy the condition

$$\vert {\int }_{- ∞}^{∞} {X}_{1} ( f ) {X}_{2} ( f ) ⅆ f \vert \leq ɛ .$$

In this particular embodiment, the two channels are not fixed, but are assigned by a channel selector 200 in dependence upon the relevant portion of the payload (pL_{ch}) of the watermark signal. Multiple channels are allowed by this system, whilst at a given time only two of the mutually independent channels are utilized. Thus the usage of the particular channels is encoded as part of the watermark payload. The amount of information that can be carried by the watermark is consequently increased by encoding the channel usage as part of the payload, without degrading the quality of the multimedia signal compared with a multimedia signal that has been watermarked utilizing two fixed mutually independent channels.

As shown in FIG. 1, a watermark selector 300 generates two sequences of values (wd1, wd2) which together correspond to a watermark. The respective portion of the payload (pL_{wm}) is used to control the watermark selector 200, and hence the relationship between the two sequences of values wd1 and wd2 that form the watermark.

Each of the two sequences of values (wd1 and wd2) from the watermark selector 300 are provided to respective mixers 130, 140. Each mixer then embeds the respective sequence of values within the respective portion of the host signal within each channel i.e. wd1 is embedded into x1 and wd2 is embedded into x2.

The resulting output signals from each mixer are passed in the direction of the adders 150, 160, and added to the original multimedia signal so as to form the watermarked multimedia signal.

Normally, the outputs of the mixers 130, 140 are re-scaled so as to minimize the impact on the multimedia signal quality. Preferably, such re-scaling is performed according to a properly chosen perceptibility cost-function, such as (in the case of acoustic signals) a psychoacoustic model of the human auditory system (HAS). Such a model is, for instance, described in the paper by E. Zwicker, “Audio Engineering and Psychoacoustics: Matching signals to the final receiver, the Human Auditory System”, Journal of The Audio Engineering Society, Vol 39, pp. Vol. 115-126, March 1991.

FIG. 2 illustrates a schematic diagram of a preferred embodiment of the channel selector 200. In this embodiment, the channel filters (110, 120) are chosen from a set of mutually independent channels using the control signal pL_{ch}, which is part of the watermark payload pL. A database of mutually independent channels (c₁, c₂, c₃, . . . c_{N}) is stored. Depending upon the value of PL_{ch} received by the channel selector 200, a selecting switch 250 selects which of the channels (210, 220, 230, 240) is utilized to provide the two mutually independent channels Ch1 and Ch2 output from the channel selector (200). The channels are mutually independent at least in one of code, time, frequency or space.

In this embodiment only a single watermark comprising two sequences of values (and thus utilizing a total of two mutually independent channels) has been embedded within the host multimedia signal. However, more than one watermark signal and/or a watermark signal comprising more than two sequences of values could be implemented. Such an implementation would require more than two mutually independent channels, and again the particular usage of the channels could be used to encode part of the watermark payload.

FIG. 3 shows one example of a watermark selector 300 suitable for use in the embedder of FIG. 1. The watermark selector 300 receives a portion of the payload (pL_{wm}) and generates two sequences of values w_{d1} and w_{d2} in dependence upon this signal. As can be seen in FIG. 3, a portion of the payload pL_{wm1} is supplied to the watermark generator 350. The watermark generator outputs two sequences of values w₁ and w₂ that have been generated in dependence upon the signal pL_{wm1}. Each of these sequences of values w₁ and w₂ are supplied to a respective circularly shifting unit (d₁, 330; d₂, 340) which circularly shifts the respective sequence of values by a predetermined amount fixed by pL_{wm2}. In other words w_{d1} is a circularly shifted version of w₁, the amount of circular shifting being predetermined based upon the value of the respective payload portion pL_{wm2}. Similarly, w_{d2} is a circularly shifted version of w₂, the amount of circular shift being determined based upon the value of pL_{wm2}. In one preferred embodiment w₁=w₂.

FIG. 4 illustrates a preferred embodiment of the watermark generator 350 utilized in FIG. 3. The watermark generator 350 comprises a random number generator (RNG) 355 which generates a sequence of random numbers by utilizing a seed value. The RNG comprises a database or a lookup table having a predetermined number of locations (351, 352, 353, 359), each holding a different seed value (s₁, s₂, s₃, . . . sₙ). The watermark generator uses part of the control (payload) pL_{wm1} to select a certain seed from the set kept in the database. Consequently, the watermark usage is also utilized to convey extra information.

In an alternative embodiment (not shown), instead of selecting the seeds from a database or a lookup table, a functional relationship between pL_{wm} is instead used to determine the value of the seed (i.e., s_{f}=(pL_{wm})).

FIG. 5 shows a schematic diagram of one possible implementation of a detector 400.

The detector 400 receives a watermarked signal y. In this particular embodiment, the payload of the watermark includes information on the channel usage. A channel selector 430 provides an estimate of the selected channels, as selected from a database (as per the channel selector shown in FIG. 2). This information is utilized to control the filters 410, 420 which respectively act to split the received signal y into channels y1 and y2. An estimation of the payload pL_{ch}, based upon the estimated channel usage, is also generated by the channel selector 430.

A watermark extraction stage 440 generates an estimate of the watermark embedded within each channel y1 and y2, and passes each estimate to a respective correlator 460, 470. These estimates are then correlated with referenced watermarks w1 and w2 to determine the detection truth-value. The referenced watermarks w1 and w2 are selected/generated by the watermark selector 450. Information on which watermarks have been selected (i.e. an estimate of pL_{wm1}, part of the signal pL_{wm}) is passed, along with the estimated channels utilized (pL_{ch}) to the payload extractor 480.

The channel selector 430 and the watermark selector 450 are arranged to continuously select new combinations of channels and watermarks until a positive detection is achieved, or until all watermark-channel combinations are exhausted. When the correlation peak exceeds a certain threshold, the momentary watermark-channel usage is analysed in the payload extraction stage to decode the encoded information. This is achieved by combining the channel usage information parameter (pL_{ch}), the watermark usage parameter (pL_{wm1}) and the circular distance between the correlation peaks (pL_{wm2}).

The circular distance between the correlation peaks is estimated by the payload extractor 480 based upon the distance between the correlation peaks passed from the correlators 460, 470.

FIG. 6 illustrates a combined output from the two correlators 460, 470, indicating the two correlation peaks and the circular distance between the correlation peaks (shown in the figure as pL_{wm2}). The horizontal scale shows the correlation delay (in terms of the sequence bins). The vertical scale on the left-hand side (referred to as the confident level cL) represents the value of the correlation peak normalized with respect to the standard deviation of the (typically normally distributed) correlation function.

As can be seen, the typical correlation is relatively flat with respect to cL, and centered about cL=0. However, the function contains two peaks, each peak corresponding to a respective successful correlation of a channel with a reference watermark. The peaks are separated by pL_{wm2}, and extend upwards to cL values that are above the detection threshold when a watermark is present. When the correlation peaks are negative, the above statement applies to the absolute values of the detection peaks.

A horizontal line (shown in the figure as being set at cL=8.7) represents the detection threshold. The detection threshold controls the false alarm rate, and can be altered depending upon the desired use of the watermark signal, and to take into account factors such as the original quality of the host signal and how badly the signal is likely to be corrupted during normal transmission.

In the particular implementation of a watermark selector 300 for an embedding apparatus shown in FIG. 3, a portion pL_{wm} of the payload (pL) corresponding to the watermark is used to set both the circular shifts d₁ and d₂ to be used (pL_{wm2}) and also the random sequences of w1 and w2 to be selected (pL_{wm1}). The relative distance between d₁ and d₂ corresponds to the distance between the correlation peaks at the detector. Thus pL_{wm2} and pL_{wm1} together correspond to pL_{wm}.

The payload extractor 480 reports the payload information only if the correlation peaks are above a predetermined threshold, otherwise it reports that the watermark has not been detected.

The relative distances between the correlation peaks correspond to the relevant part of the payload. By using mutually independent channels, it is ensured that the channels do not interfere with each other and corrupt the watermark sequences embedded within each channel. As time offset between the detector and receiver will affect both channels, the relative delays (circular-shifts) between the sequences of values within each channel will remain constant, and immune to the relative offset between the embedder and the detector. The same applies to time scale modifications.

Various modifications of the above method and apparatus will be apparent to the skilled person. For instance, whilst the above embodiment has described encoding the channel usage as part of the payload, the method and apparatus could be implemented simply using two (or more) predetermined mutually independent channels. In such an instance, the embedding and detecting apparatus would clearly not include channel selectors 200, 430.

Alternatively, the channels could be selected based upon characteristics of the multimedia signal such as the energy levels within each channel and/or a perceptibility cost-function, so as to minimize the perceived impact of the watermark on the multimedia signal.

Various modifications may also be made to the watermark selector 300 in the embedder. For instance, although the watermark has been described as a sequence of values it will be appreciated that in order to diminish the impact of the embedded watermark on the host signal quality, each value may be modified by a smooth window shaping function. Further, whilst the above embodiment has been described as utilizing two different sequences of values w₁ and w₂ it will be appreciated that a single sequence of values can be used i.e. w₁=w₂.

FIG. 7 shows an alternative combined watermark/channel selector, based on a code multiplexing approach. In this particular instance, the separate channels are provided by modulation of the host signal with mutually independent basis functions, rather than separation of the multimedia signal into distinct watermark channels. The mutual independence is achieved by relatively shifting the basis functions over time. The channel selection is achieved by choosing the time delay from a predetermined set. FIGS. 7, 8A and 8B illustrate this concept.

As can be seen in FIG. 7, two watermark sequences w₁[k] and w₂[k] are received by the apparatus 500, and pass through respective signal conditioning filters 510, 520. The signal conditioning filters 510, 520 act to apply a window shaping function to each value of the respective series w₁[k] and w₂[k].

FIG. 8A shows an example of a suitable bi-phase window shaping function of width Tₛ.

The mutual independence of the resulting channels is achieved by relatively shifting the basis functions over time, with the channel selection being achieved by choosing the delay from a predetermined set. This can be seen in FIG. 8B which illustrates the use of two alternative delays (T₁ and T₂) being applied to the window shaped version of w₂[k], with the window shaped version of w₁[k] also being indicated.

This delay would be set by the delay unit 540, and controlled by the delay selector 530 in dependence upon the channel part of the payload [pL_{ch}]. As the two watermark signals are mutually independent, they can be added together by adder 550 to form a single watermark signal w_{pL}[n], which is subsequently embedded into the host multimedia signal.

FIG. 9 illustrates an embodiment of a signal conditioning apparatus 500, along with charts indicating the relevant signals at each stage. Such an apparatus 500 could be used to implement the signal conditioning filters 510, 520 shown in FIG. 7. In the units 510, 520 shown in FIG. 7, the input w[k] corresponds to w₁[k] or w₂[k], and the output w_{c}[n] to outputs w_{c1}[n] or w_{c2}[k].

In the conditioning circuit, the input watermark signal sequence w[k] is first applied to the input of an up-sampler 652. Chart 651 illustrates one of the possible sequences [k] as a sequence of values of random numbers between +1 and −1, with the sequence being of length L_{w}. The up-sampler adds (Tₛ−1) zeros between each sample so as to raise the sampling frequency by the factor Tₛ. Tₛ is referred to as the watermark symbol period and represents the span of the watermark symbols in the audio signal. Chart 653 shows wᵢ[n], the results of the signal illustrated in chart 651 once it has passed through the up-sampler 652.

A window shaping function s[n], such as a bi-phase window, is then convolved by the convolving unit 656 with the up-sampled signal wᵢ[n] so as to convert it into a slowly varying narrow-band signal w_{c}[n], whose behavior for the w[k] sequence of chart 651 is as shown in chart 657.

Chart 654 shows a typical bi-phase window shaping function. The window shaping function is applied to the watermark sequence in order to produce a smoothly varying signal, so as to minimize the decrease in the quality of the host signal.

It will be appreciated by the skilled person various implementations not specifically described will be understood as falling within the scope of the present invention. For instance, whilst only the functionally of the embedding and detecting apparatus has been described, it will be appreciated that the apparatus could be realized as a digital circuit, an analog circuit, a computer program or a combination thereof.

Within the specification it will be appreciated that the words “comprising” does not exclude other elements or steps, that “a” or “an” does not exclude a plurality, and that a single processor or other unit may fulfill the functions of several means recited in the claims.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of embedding a watermark in a multimedia signal, the method comprising:
generating a watermark signal comprising a first sequence of values and a second sequence of values;
obtaining a first signal portion corresponding to a first channel and a second signal portion corresponding to a second channel from the multimedia signal, said channels being significantly independent;
generating a first host modifying signal as a mixture of the first signal portion and the first sequence;
generating a second host modifying signal as a mixture of the second signal portion and the second sequence; and
generating a watermarked multimedia signal by combining scaled versions of the host modifying signals with the multimedia signal.

2. A method as claimed in claim 1, wherein the first and second channels are selected from a predetermined set of significantly independent channels.

3. A method as claimed in claim 2, wherein said channel selection occurs in dependence upon a payload of the watermark signal.

4. A method as claimed in claim 2, wherein said channel selection occurs in dependence upon predetermined characteristics of the multimedia signal.

5. A method as claimed in claim 1, wherein the first and second sequences are selected from a predetermined set of watermark sequences.

6. A method as claimed in claim 5, wherein the watermark selection occurs in dependence upon a payload of the watermark signal.

7. A method as claimed in claim 1, wherein said watermark comprises at least one further sequence of values; and the method further comprises the steps of:
obtaining at least one further signal portion corresponding to a further channel from the multimedia signal, said first, second, and said further channel being significantly independent;
generating at least one further host modifying signal as a mixture of said further sequence and said further signal portion.

8. A method as claimed in claim 1, wherein said channels are obtained from the multimedia signal by filtering the multimedia signal using at least one of time filters, frequency filters or spatial filters.

9. A method as claimed in claim 1, wherein said channels are obtained by applying orthogonal data projection techniques into orthogonal code spaces.

10. A method as claimed in claim 1, wherein said first and second channels are mutually orthogonal.

11. A method as claimed in claim 1, wherein said second sequence of values is a circularly shifted version of said first sequence of values.

12. A method as claimed in claim 1, wherein said first and second signal portions are substantially the same.

13. A method as claimed in claim 1, wherein said first and second sequence of values are substantially the same.

14. An apparatus arranged to embed a watermark in a multimedia signal, the apparatus comprising:
a watermark signal generator arranged to generate a watermark signal comprising a first sequence of values and a second sequence of values;
a channel signal portion extractor arranged to obtain a first signal portion corresponding to a first channel and a second signal portion corresponding to a second channel from the multimedia signal, said channels being significantly independent;
a host signal modifier arranged to generate a first host modifying signal as a mixture of the first signal portion and the first sequence; and further arranged to generate a second host modifying signal as a mixture of the second signal portion and the second sequence; and a combiner arranged to generate a watermarked multimedia signal by combining scaled versions of the first and second host modifying signals with the multimedia signal.

15. An apparatus as claimed in claim 14, the apparatus further comprising a database of significantly independent channels; and a channel selector arranged to select the first and second channels from said database.

16. A multimedia signal comprising a watermark, the watermark comprising at least a first sequence of values and a second sequence of values, and wherein a first signal portion corresponding to a first channel within the multimedia signal has been modified by the first sequence of values, and a second signal portion corresponding to a second channel within the multimedia signal has been modified by a second sequence of values, the first and second channels being significantly independent.

17. A method of detecting a watermark signal embedded in a multimedia signal, the method comprising the steps of:
receiving a multimedia signal that may potentially be watermarked by a watermark signal embedded within two significantly independent channels of the multimedia signal; extracting an estimate of the watermark from the two significantly independent channels of the received signal; and
correlating the estimate of the watermark with a referenced version of the watermark so as to determine whether the received signal is watermarked.

18. A method as claimed in claim 17, wherein the watermark signal has a payload, and the method further comprises the step of determining the payload of the watermark.

19. A method as claimed in claim 17, wherein the method includes receiving, and extracting an estimate of the watermark from, three or more channels.

20. A watermark detector apparatus arranged to detect whether a watermark signal is embedded within a multimedia signal, the watermark detector comprising: a receiver arranged to receive a multimedia signal that may potentially be watermarked by a watermark signal embedded within two significantly independent channels of the multimedia signal; a filter arranged to extract an estimate of the watermark from the two significantly independent channels of the received signal; and
a correlator arranged to correlate the estimate of the watermark with a referenced version of the watermark so as to determine whether the received signal is watermarked.

21. An apparatus as claimed in claim 20, wherein the apparatus further comprises a detector arranged to determine if a payload is present within said watermark, and to determine the value of said payload.

22. A computer program arranged to perform at least one of the methods of claim 1 and the method of claim 17.

23. A record carrier comprising a computer program as claimed in claim 22.

24. A method of making available for downloading a computer program as claimed in claim 22.
